(19) United States
(12) Patent Application Publication
(10) Pub. No.: US 2019/0174293 A1
(43) Pub. Date: Jun. 6, 2019

(54) METHOD AND APPARATUS FOR FORMING A NETWORK

(71) Applicant: MOTOROLA SOLUTION, INC, CHICAGO, IL (US)

(72) Inventors: STEVEN JOHN KERR, PENANG (MY); CHONG HIN CHEE, PENANG (MY); LEE SUN OOI, KULIM (MY)

(21) Appl. No.: 15/535,465

(22) PCT Filed: Jul. 11, 2016
(86) PCT No.: PCT/MY2016/000039

§ 371 Date: Jun. 13, 2017

(51) Int. Cl. H04W 8/00; H04L 12/24; H04W 76/10

(52) U.S. Cl. CPC H04W 8/005; H04W 84/18; H04W 76/10; H04L 41/12

(57) ABSTRACT

A method and apparatus for quickly forming a PAN is describe herein. During operation a device will detect that it has gone from a charging state to a non-charging state (i.e., a battery not being charged). Moving from a charging state to a non-charging state is utilized as a trigger to form or join a PAN. Thus, a PAN can quickly be formed at the beginning of an officer's shift, simply by removing devices from a charger.

### RELATED APPLICATIONS

The present invention is related to co-pending patent application serial number (Docket No. CM18962), entitled METHOD AND APPARATUS FOR DISASSOCIATING FROM A NETWORK, and filed on the same day as the present application.

### FIELD OF THE INVENTION

The present invention generally relates to forming a network, and more particularly to a method and apparatus for forming a network based upon the detection of a battery going from a charging state to a non-charging state.

### BACKGROUND OF THE INVENTION

Next-generation public safety officers will be equipped with devices that determine various physical and environmental conditions surrounding the public-safety officer. These conditions are generally reported back to a dispatch operator so an appropriate action may be taken. For example, future police officers may have a sensor that determines when a gun is drawn. Upon detecting that an officer has drawn their gun, a notification may be sent back to the dispatch operator so that, for example, other officers in the area may be notified of the situation.

It is envisioned that the public-safety officer of the future will have an array of shelved devices available to the officer at the beginning of a shift. The officer will select the devices off the shelf, and form a personal area network (PAN) with the devices that will accompany the officer on his shift. For example, the officer may pull a gun-draw sensor, a body-worn camera, a wireless microphone, a smart watch, a police radio, a man-down sensor, . . . , etc. All devices pulled by the officer will be configured to form a PAN by associating (pairing) with each other and communicating wirelessly among the devices.

A method called bonding is typically used for recognizing specific devices and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device.

Thus, pairing and unpairing typically involves some level of user interaction. This user interaction is the basis for confirming the identity of devices. Once pairing successfully completes, a bond will have been formed between the two devices, enabling those two devices to connect to each other in the future without again requiring the pairing process. When desired, the bonding relationship can later be removed by the user. Because devices are pulled randomly at the beginning of a shift, an officer may pull a different array of devices every time they form a PAN. This requires that old bonds be cleared from every device at the end of a shift, and new be formed every time the officer pulls devices at the beginning of their shift.

A problem with the above-described scenario is that forming a PAN at the beginning of a shift from the pulled devices, as well as un-forming the PAN at the end of the shift from the pulled devices can take a considerable amount time for the officer. For example, a public-safety officer will need to access each device and “associate/pair” the device to the PAN at the beginning of their shift. In a similar manner, the public-safety officer will need to access each device and “disassociate/unpair” the device from the PAN at the end of their shift. This will take a considerable amount of time and effort. Considering this fact, there is a need for a method and apparatus for quickly forming a PAN that requires little user interaction to do so.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operational environment for the present invention.

FIG. 2 depicts an example communication system.

FIG. 3 depicts a more-detailed view of the personal-area network of FIG. 1.

FIG. 4 is a block diagram of a PAN device of FIG. 1 and FIG. 2.

FIG. 5 is a flow chart showing operation of the PAN device of FIG. 4.

FIG. 6 is a flow chart showing operation of the PAN device of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for quickly forming a PAN is describe herein. During operation a device will detect that it has gone from a charging state to a non-charging state (i.e., a battery not being charged). Moving from a charging state to a non-charging state is utilized as a trigger to form or join a PAN. Thus, a PAN can quickly be formed at the beginning of an officer's shift, simply by removing devices from a charger.

In a further embodiment of the present invention a time period is also utilized to form the PAN. In particular, a PAN is only joined/formed for a predetermined amount of time (e.g., 5 seconds) after going from a charging state to a non-charging state. This is to prevent the device from continuously joining a PAN during the whole period the device is in the non-charging state (i.e., not being charged).

When multiple devices are configured as described above, all devices will attempt to join a PAN with other devices when pulled off a particular charger. So, for example, when five devices are pulled off a charger in quick succession (e.g., within five seconds), the five devices will form a PAN.

In a further embodiment of the present invention a received signal strength indication (RSSI) is also utilized to form a PAN. More particularly, a presumption is made that if more than one device is being removed from a charger by a single user at about the same time, the devices will be in close proximity to each other. Therefore the RSSI of each device may be utilized as a secondary trigger to form a PAN. Thus, when a device goes from a charging state to a non-charging state, the device may automatically pair with other devices having an RSSI greater than a predetermined threshold. In an alternate embodiment, the signal strength may be measured to see if it is increasing over time. If so, this may ensure that devices pulled from a rack are being brought together. An alternate threshold for pairing devices may be that their signal strength is increasing over time.

In yet a further embodiment of the present invention, charger identification (ID) may be utilized as a further trigger to pair, or form a PAN. Elaborating a bit more on the above, when not in use, it is assumed devices will be stored on a charger at, for example a police station. This fact can be leveraged to aide in quickly forming a PAN. More particularly, a charger identification (ID) can also be used to trigger formation a PAN, such that removing a device from a particular charger (e.g., the charger at the police station) will automatically cause the device to form/join a PAN without any input from the user.

It should be noted that simply removing the device on any charger may not be enough to cause a device to form a PAN. The device may need to be removed from a particular charger(s) in order for PAN formation to take place. The particular charger may be determined via a charger ID. For example, a device may be charged in the field (for example within the officer's automobile). When in the field, removing the device from a charger will not cause the formation of a PAN. However, when the same device is charged at the police station, removing the device from the charger will cause the device to form or join a PAN. It should also be noted that removing a device from more than one charger may cause PAN formation, so that any number of chargers may be utilized at, for example, the police station.

It should be noted that the terms associate, associating, pair, pairing, form, and forming can be used interchangeably, and simply mean that a device is added to an existing PAN, or a PAN is created with the device as a member. The PAN described above that is formed between devices preferably comprises a wireless PAN that comprises a low-powered PAN carried over a short-distance wireless network technology such as PANs formed using the following standards: INSTEON, IrDA, Wireless USB, Bluetooth, Z-Wave, ZigBee, and Body Area Network. The reach of a wireless PAN varies from a few centimeters to a few meters. Associating/pairing and disassociating/unpairing a device from the PAN is well known in the art, and takes place as instructed by any of the above standards.

As one of ordinary skill in the art will recognize, during the formation of a Bluetooth PAN there is typically one master device (hub) and one or more slave devices. The number of slave devices is limited by the capability of the master device. All communication within a PAN is between the master and slave devices. There is no direct communication between the slave devices over a PAN, although these devices may have separate Bluetooth connections between them that does not use the PAN.

After a PAN is established, the slave devices are synchronized to the timing and frequencies specified by the master device (sometimes referred to as a hub). Note that in a PAN, each slave device uses a different physical channel. Thus, a PAN starts with two connected devices, and may grow to any number of connected devices (although in some systems eight is the maximum number of devices within a Bluetooth PAN). Bluetooth communication always designates one of the Bluetooth devices as a main controlling unit or master unit. Other devices that follow the master unit are slave units. This allows the Bluetooth system to be non-contention based (no collisions). This means that after a Bluetooth device has been added to the PAN, each device is assigned a specific time period to transmit and they do not collide or overlap with other units operating within the same PAN.

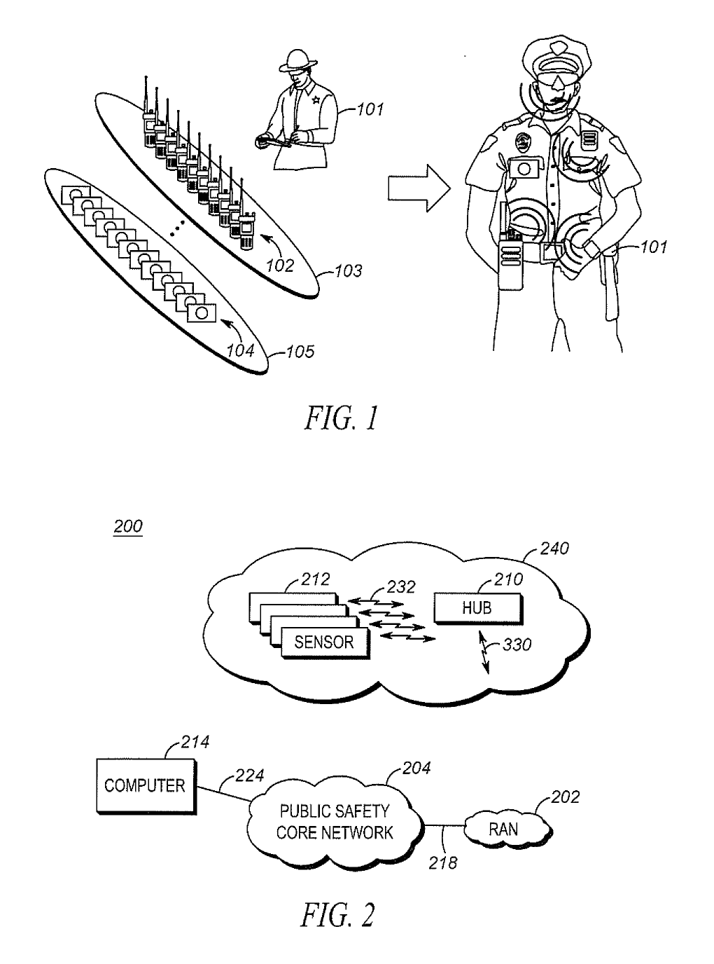

FIG. 1 depicts a general operating environment for the above-described technique for forming a PAN. As shown, public-safety officer 101 has an array of devices 102 and 104 to use during the officer's shift. For example, the officer may pull one radio 102 and one camera 104 for use during their shift. Other devices may be pulled as well. As shown, devices 102 and 104 may be located on a charger 103/105. Chargers 103 and 105 will have a unique charger ID that is communicated to device 102/104 through its charging port (i.e., point on a device 102/104 where they come into physical contact with chargers 103/105).

When any device 102/104 is placed in/on chargers 103/105, the devices will proceed into a charging state and the charger ID will be detected by the device. The device can receive the charger ID thru any technique that convey an ID, for example, near-field communications (NFC) or via direct charging contact/ports.

As shown in FIG. 1, officer 101 will preferably wear the devices during a shift by attaching the devices to worn clothing. These devices will for a PAN throughout the officer's shift.

FIG. 2 depicts an example communication system 200 that incorporates PANs created as described above. System 200 includes one or more radio access networks (RANs) 202, a public-safety core network 204, hub (PAN master device) 210, local devices (slave devices) 212, a computer 214, and communication links 218, 224, and 232. In a preferred embodiment of the present invention, hub 210 and devices 212 form a PAN 240, with communication links 232 between devices 212 and hub 210 taking place utilizing a short-range communication system protocol such as a Bluetooth communication system protocol.

Each RAN 202 includes typical RAN elements such as base stations, base station controllers (BSCs), routers, switches, and the like, arranged, connected, and programmed to provide wireless service to user equipment (e.g., hub 210, and the like) in a manner known to those of skill in the relevant art.

The public-safety core network 204 may include one or more packet-switched networks and/or one or more circuit-switched networks, and in general provides one or more public-safety agencies with any necessary computing and communication needs, transmitting any necessary public-safety-related data and communications.

The hub 210 may be any suitable computing and communication devices configured to engage in wireless communication with the RANs 202 over the air interface as is known to those in the relevant art. Moreover, one or more hub 210 are further configured to engage in wired and/or wireless communication with one or more local device 212 via the communication link 232. Hub 210 will be configured to determine when to forward information via RANs 202 based on a combination of device 212 inputs.

Devices 212 and hub 210 may comprise any device capable of forming a PAN. For example, devices 212 may comprise a gun-draw sensor, a camera, a GPS receiver capable of determining a location of the user device, a clock, calendar, environmental sensors (e.g. a thermometer capable of determining an ambient temperature, humidity, presence of dispersed chemicals, radiation detector, etc.), an accelerometer, a barometer, speech recognition circuitry, a gunshot detector, . . . , etc.

Any one or more of the communication links 218, 224, could include one or more wireless-communication links and/or one or more wired-communication links.

Finally, computer 214 is part of a computer-aided-dispatch center, manned by an operator providing necessary dispatch operations. For example, computer 214 typically comprises a graphical user interface that provides the dispatch operator necessary information about public-safety officers. As discussed above, much of this information originates from devices 212 providing information to hub 210, which forwards the information to RAN 202 and ultimately to computer 214.

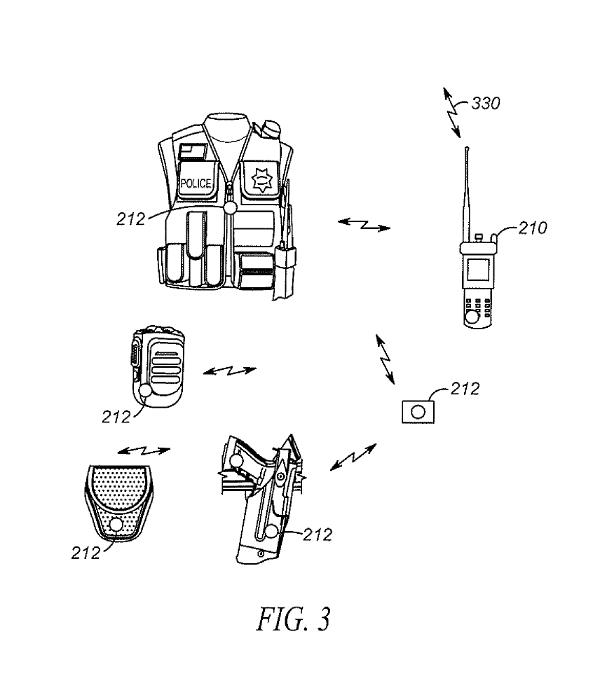

FIG. 3 depicts a more-detailed view of the personal-area network of FIG. 2. Personal-area network comprises a very local-area network that has a range of, for example 10 feet. As shown in FIG. 3, various devices 212 are shown attached to equipment utilized by a public-safety officer. In this particular example, a bio-sensor is located within a police vest, a voice detector is located within a police microphone, a handcuff deployment sensor is located with a handcuff pouch, a gun-draw sensor is located within a holster, and a camera 212 is provided. In FIG. 3, all sensors (except for camera 212) are represented by circles attached to an item to be monitored.

Devices 212 and hub 210 form a PAN 240. PAN 240 preferably comprises a Bluetooth PAN. Devices 212 and hub 210 are considered Bluetooth devices in that they operate using a Bluetooth, a short range wireless communications technology at the 2.4 GHz band, commercially available from the “Bluetooth special interest group”. Devices 212 and hub 210 are connected via Bluetooth technology in an ad hoc fashion forming a PAN. Hub 210 serves as a master device while devices 212 serve as slave devices. Devices 212 notify hub 210 of a sensed condition by sending a local status alert transmitted from the sensor as a Bluetooth message. Hub 210 in turn, may forward the local status alert over a wide-area network (e.g., RAN/Core Network) to computer 214. In alternate embodiments of the present invention, hub 210 may forward the local status alert to mobile and non-mobile peers (shift supervisor, peers in the field, etc), or to the public via social media.

As discussed above, a problem exists in that forming a PAN at the beginning of a shift from the pulled devices, as well as un-forming the PAN at the end of the shift from the pulled devices can take a considerable amount time and effort for the officer. For example, a public-safety officer will need to access each device and “associate/pair” the device to the PAN at the beginning of their shift. In a similar manner, the public-safety officer will need to access each device and “disassociate/unpair” the device from the PAN at the end of their shift.

In order to address this issue, a method and apparatus for quickly forming a PAN is describe herein. During operation, a device 210/212 will detect that it has gone from a charging state to a non-charging (i.e., a battery not being charged). Moving from a charging state to a non-charging state is utilized as a trigger to automatically form or join a PAN with minimal, or no user input. Thus, a PAN can quickly be formed at the beginning of an officer's shift, simply by removing all devices from a charger in quick succession.

As discussed above, the PAN will be joined or formed with devices detected within a predetermined time period after going from the charging state to the non-charging state.

Additionally, a received signal strength indication (RSSI) can also be utilized to form a PAN. More particularly, during operation, a device 210/212 will detect that it has gone from a charging state to a non-charging (i.e., a battery not being charged). Moving from a charging state to a non-charging state is utilized as a trigger to automatically form or join a PAN with devices having an RSSI above a particular threshold (e.g., 10 mW).

As discussed above, charger identification (ID) may be utilized as a further trigger to pair, or form a PAN, such that removing a device from a particular charger will automatically cause the device to form/join a PAN without any input from the user. More particularly, during operation, a device 210/212 will detect that it has gone from a charging state to a non-charging (i.e., a battery not being charged). Device 210/212 will also detect a particular charger ID. Moving from a charging state on a particular charger (as determined from the ID) to a non-charging state is utilized as a trigger to automatically form or join a PAN. The PAN may be formed only with devices having an RSSI above a particular threshold (e.g., 10 mW).

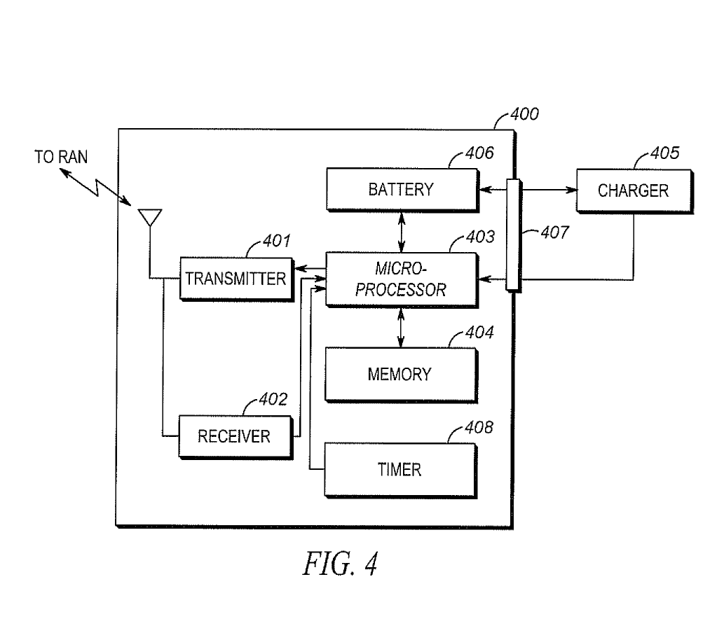

FIG. 4 is a block diagram of a PAN device 400 (e.g., hub 210 or device 212) of FIG. 1 through FIG. 3. As shown, device 400 may include transmitter 401, receiver 402, battery 406, logic circuitry 403, timer 408, and memory 404. In other implementations, device 400 may include more, fewer, or different components.

Transmitter 401 and receiver 402 may be well known long-range and/or short-range transceivers that utilize any number of network system protocols. For example, transmitter 401 and receiver 402 may be configured to utilize Bluetooth communication system protocol for a body-area network, a private 802.11 network, a next-generation cellular communications protocol operated by a cellular service provider, or any public-safety protocol such as an APCO 25 network or the FirstNet broadband network. Although only a single transmitter and receiver are shown in FIG. 4, one of ordinary skill in the art will recognize that multiple transmitters and receivers may exist in device 400 to provide simultaneous communications using any number of communication system protocols.

Battery 406 provides a way of powering sensor 400. In a particular embodiment, battery 406 is rechargeable and recharged by placement in contact with charger 405 at port 407. Thus port 407 serves as a physical connection between battery 406 and charger 405. Port 407 can also facilitate communication between charger 405 and device 400 through their contact points. In the situation where charger 405 is a wireless charger, port 407 comprises a receiver that is both used to charge and receive data, for example a charger ID. Thus, charger 405 preferably comprises a device capable of generating a charging voltage and unique charger identification.

It should be noted that battery 406 and charger 405 comprise standard elements that are well known in the art of charging and powering devices. For example, battery 406 can comprise a standard lithium-ion battery that is capable of direct and/or wireless charging when brought into contact/vicinity of charger 405.

Timer 408 outputs a time, and is utilized as a time source in order to determine an amount of time that has elapsed since the removal of battery 406 from charger 405.

Logic circuitry 403 comprises a digital signal processor (DSP), general purpose microprocessor, a programmable logic device, or application specific integrated circuit (ASIC) and is configured to detect when to pair with a PAN. In particular, logic circuitry 403 is configured to:
detect when device 400 goes from a charging state to a non-charging state; and/or
detect a signal strength of other devices 400; and/or
detect that battery 406 is being charged by a particular charger having a particular charger ID; and/or
determine a period of time after going from the charging state to the non-charging state.

The detection when device 400 goes from the charging state to the non-charging state is accomplished by logic circuitry 403 being coupled to battery 406, and/or battery port 407, and detecting when no charging voltage exists across battery 406 or port 407. In addition, the detection of the signal strength of other devices takes place by logic circuitry 403 accessing receiver 402 and determining a signal strength for all signals received by receiver 402. The detection of the charger ID is accomplished by logic circuitry 403 receiving this ID from charger 405 through battery 406 or port 407. Finally, the determination of the time period is accomplished by accessing timer 408 to determine a period of time since battery 406 was removed from charger 405.

Thus, the apparatus of FIG. 4 comprises an apparatus comprising a battery being capable of being charged by a battery charger, and logic circuitry coupled to the battery, the logic circuitry detecting that the battery going from a charging state to a non-charging state, the logic circuitry forming a network with other devices based on the battery going from the charging state to the non-charging state.

One of ordinary skill in the art will recognized that the PAN network is formed by logic circuitry 403 instructing transmitter 401 to transmit necessary information for pairing to (or forming) a PAN. In addition logic circuitry 403 will instruct receiver 402 to listen for necessary PAN-forming messages transmitted by other devices. PAN formation takes place as described in, for example, the Bluetooth standard.

As discussed above, timer 408 is provided and logic circuitry 403 utilizes timer 408 to determine an amount of time that has elapsed since device 400 has been removed from charger 405. PAN formation may only take place with devices detected (i.e., those transmitting PAN association/forming messages) during a predetermined time period (e.g., 5 seconds) after being removed from charger 405. In other words, once logic circuitry 403 detects battery 406 going from a charging state to a non-charging state, a PAN will be formed with devices detected within, for example, 5 seconds.

As discussed above, wireless receiver 402 may be utilized to detect RSSI of signals from other devices, and the logic circuitry can form the network by forming the network with other devices having a signal strength above a predetermined threshold, and also based on the battery going from the charging state to the non-charging state.

As discussed above, charging port 407 may be provided a battery charger identification (ID), and the logic circuitry forms the network by forming the network with other devices having the signal strength above the predetermined threshold, and also based on the battery going from the charging state to the non-charging state, and also based on the battery charger ID. Logic circuitry may check memory 404 to determine if the particular battery charger ID matches any battery charger ID within memory 404, and if so, network formation takes place.

As discussed above, wired or wireless charging port 407 may be provided a battery charger identification (ID), and the logic circuitry forms the network with other devices based on the battery going from the charging state to the non-charging state, and also based on the battery charger ID. Logic circuitry may check memory 404 to determine if the particular battery charger ID matches any battery charger ID within memory 404, and if so, network formation takes place.

As discussed above, the network may comprise a personal area network (PAN).

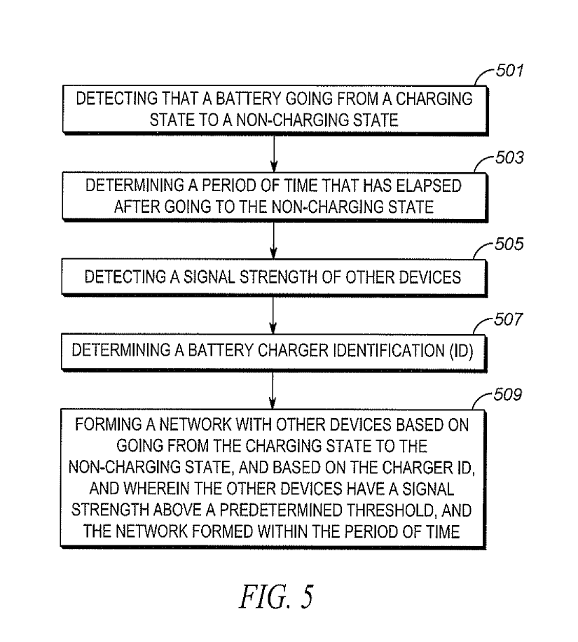

FIG. 5 is a flow chart showing operation of the device of FIG. 4. It should be noted that all steps shown in FIG. 4 are not necessary, some may be optional. The logic flow begins at step 501 where logic circuitry 403 detects a battery 406 going from a charging state to a non-charging state. This may be accomplished by determining a voltage change across port 407 or battery 406, or any other mechanism that determines that device 400 has been removed from charger 405 (voltage drops to zero, from some positive number). At step 503, logic circuitry 403 accesses timer 408 to determine a period of time that has elapsed after going to the non-charging state (or alternatively, a period of time after being removed from charger 405). At step 505 logic circuitry 403 accesses receiver 402 and detects a signal strength of other devices. A battery charger identification (ID) may also be determined (step 507). Finally, at step 509, logic circuitry 403 instructs transmitter 401 and receiver 402 to form a PAN via standard network-forming techniques. As discussed above, the network may be formed with other devices based on going from the charging state to the non-charging state or being removed from charger 405 within a predetermined period of time. In alternate embodiments of the present invention the formation may take place only after being removed from a charger having a particular charger ID. In yet a further embodiment of the present invention the network may be formed with only those devices having a signal strength above a predetermined threshold.

With the above in mind:
The step of forming the network with the other devices may be based on the battery going from the charging state to the non-charging state.
The step of forming the network with the other devices may be based on the battery being removed from a charger.
The step of forming the network with the other devices may be based on the battery being removed from a charger having a particular ID.
The other devices may be required to having the signal strength above a predetermined threshold in order to join a PAN with them.
The network may only be formed within a predetermined period of time after the device has been removed from the charger.

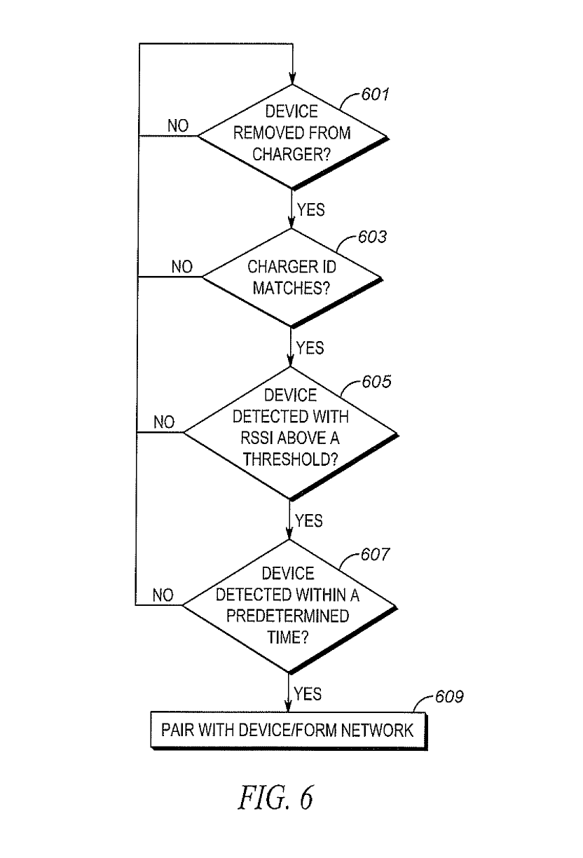

FIG. 6 is a flow chart showing operation of the PAN device of FIG. 4. It should be noted that not all steps are necessary in FIG. 6. The logic flow begins at step 601 where logic circuitry detects if a device has been removed from a charger. If not, the logic flow returns to step 601, otherwise the logic flow continues to step 603 where the logic circuitry determines if a charger ID matches a particular charger ID. If the charger ID does not match, the logic flow returns to step 601, otherwise the logic flow continues to step 605 where the logic circuitry determines if any other device has been detected with an RSSI above a predetermined threshold. If not, the logic flow returns to step 601, If, however another device has been detected with a signal strength above the predetermined threshold, the logic flow continues to step 607 where logic circuitry determines if the other device has been detected within a predetermined period of time since the device was removed from the charger. If not, the logic flow returns to step 601. If so, the logic flow continues to step 609 where the logic circuitry instructs the device to pair with the other device as part of a PAN.

In the foregoing specification, specific embodiments have been described. However, one of ordinary skill in the art appreciates that various modifications and changes can be made without departing from the scope of the invention as set forth in the claims below. For example, while the above technique was described with reference to forming/associating with a PAN, one of ordinary skill will recognize that a PAN, or association with any network may be achieved as described above. For example, association with a LAN may be performed as described above. Also, the “detection” of a battery charger ID may also comprise the detection of no battery charger ID. In other words, the fact that a charger does not output an ID comprises the detection of a battery charger ID equal to “no” ID. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for a device to form a network, the method comprising the steps of:
detecting that a battery going from a charging state to a non-charging state; and
forming the network with other devices based on the battery going from the charging state to the non-charging state.

2. The method of claim 1 further comprising the steps of:
detecting a signal strength of the other devices; and
wherein the step of forming the network with the other devices further comprises the step of forming the network with other devices having the signal strength above a predetermined threshold, and also based on the battery going from the charging state to the non-charging state.

3. The method of claim 2 further comprising the steps of:
determining a battery charger identification (ID); and
wherein the step of forming the network with the other devices further comprises the step of forming the network with other devices having the signal strength above the predetermined threshold, and also based on the battery going from the charging state to the non-charging state, and also based on the battery charger ID.

4. The method of claim 1 further comprising the steps of:
determining a battery charger identification (ID); and
wherein the step of forming the network with the other devices further comprises the step of forming the network with other devices based on the detection of the battery charger ID and also based on the battery going from the charging state to the non-charging state.

5. The method of claim 1 further comprising the steps of:
determining a time; and
forming the network with other devices within a predetermined time of the battery going from the charging state to the non-charging state.

6. The method of claim 1 wherein the network comprises a personal area network (PAN).

7. The method of claim 1 wherein the step of forming the network comprises the step of pairing/associating with the network.

8. An apparatus comprising:
a battery being capable of being charged by a battery charger;
logic circuitry coupled to the battery, the logic circuitry detecting that the battery is going from a charging state to a non-charging state, the logic circuitry forming a network with other devices based on the battery going from the charging state to the non-charging state.

9. The apparatus of claim 8 further comprising:
a wireless receiver detecting a signal from other devices; and
wherein the logic circuitry forms the network by forming the network with other devices having a signal strength above a predetermined threshold, and also based on the battery going from the charging state to the non-charging state.

10. The apparatus of claim 9 further comprising:
a charging port receiving a battery charger identification (ID); and
wherein the logic circuitry forms the network by forming the network with other devices having the signal strength above the predetermined threshold, and also based on the battery going from the charging state to the non-charging state, and also based on the battery charger ID.

11. The apparatus of claim 8 further comprising:
a charging port receiving a battery charger identification (ID); and
wherein the logic circuitry forms the network by forming the network with other devices based on the detection of the battery charger ID and also based on the battery going from the charging state to the non-charging state.

12. The apparatus of claim 8 wherein the network comprises a personal area network (PAN).

13. The apparatus of claim 8 wherein forming the network comprises pairing/associating with the network.

14. The apparatus of claim 8 further comprising:
a timer outputting a time; and
the logic circuitry forms the network by forming the network with other devices within a predetermined time of the battery going from the charging state to the non-charging state.

15. A method comprising the steps of:
detecting that a battery going from a charging state to a non-charging state;
determining a period of time that has elapsed after going to the non-charging state;
detecting a signal strength of other devices;
determining a battery charger identification (ID); and
forming a network with other devices based on going from the charging state to the non-charging state, and based on the battery charger ID, and wherein the other devices have a signal strength above a predetermined threshold, and the network formed within the period of time.
